(19) United States
(12) Patent Application Publication
(10) Pub. No.: US 2008/0270171 A1
(43) Pub. Date: Oct. 30, 2008

(54) Method and system for managing caselog fraud and chargeback

(76) Inventors: Bryan Price, Columbus, GA (US); Christy Andrews, Phenix City, AL (US); Tim Edgar, Pine Mountain, GA (US); Zhonghua Zhou, Midland, GA (US)

Correspondence Address: KING & SPALDING LLP, 1180 PEACHTREE STREET, ATLANTA, GA, 30309-3521, US

(21) Appl. No.: 12/150,154

(22) Filed: Apr. 25, 2008

Related U.S. Application Data
(60) Provisional application No. 60/926,697, filed on Apr. 27, 2007.

(51) Int. Cl. G06Q 90/00

(52) U.S. Cl. 705/1

(57) ABSTRACT

Managing caselog fraud and chargeback. The systems and methods include the ability to manage a fraud case in a fraud queue; automatically locate the data associated with the fraud case; display workflows on a customized graphical user interface; automatically navigate through workflows that are based on predetermined rules specific to an account-provider, business, or regulation; store activity and data related to each fraud case; and automatically update the fraud queue. The systems and methods include a fraud analyst workstation, a workflow engine, a host computer system, and a workflow database. The fraud analyst workstation communicates with the workflow engine, which stores and the workflows. The workflow engine communicates with the host computer system to access data associated with the fraud case. The workflow engine communicates with a workflow database, which stores activity and data related to each fraud case for purposes of tracking, billing, and research.

### STATEMENT OF RELATED PATENT APPLICATIONS

This non-provisional patent application claims priority under 35 U.S.C. § 119 to U.S. Provisional Patent Application No. 60/926,697, titled Method and System for Caselog Fraud and Chargeback, filed Apr. 27, 2007. This provisional application is hereby fully incorporated herein by reference.

### FIELD OF THE INVENTION

This invention relates to systems and methods for managing caselog fraud and chargeback. More particularly, this invention relates to processes and systems that allow fraud analysts or other users to more efficiently manage fraud cases in financial transactions.

### BACKGROUND OF THE INVENTION

The use of financial cards for conducting financial transactions is ubiquitous. Typically, a credit card represents a line of credit that has been issued from a financial institution, the account provider, to an individual, the account holder. The credit card allows the account holder to purchase goods and services against the line of credit. The line of credit is associated with an account and that account has certain terms governing how credit is extended to the account holder. Typical terms include an annual interest rate charged on the amount of money actually lent to the account holder, a grace period that allows the account holder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM.

In addition to credit cards, debit cards allow an account holder to withdraw funds directly from their bank account. Accordingly, purchases are not made on credit, but with funds in an account linked to the particular debit card. Generally, debit cards are issued by financial institutions.

Prepaid cards provide another method to make purchases. A prepaid card has access to a predetermined amount of funds. The predetermined amount is paid in advance of using the card. Each time it is used, the purchase amount is deducted from the prepaid amount.

Credit cards, debit cards, and prepaid cards are used by account holders to make purchases at a variety of institutions. Systems exist to monitor an account's activity to identify fraud. Such systems use logic and algorithms to generate a list of accounts that may have undergone fraudulent activity. In addition, account holders can identify potentially fraudulent activity, by, for example, alerting the issuing entity of suspicious charges. Each account that is identified as having undergone actual fraudulent activity is typically managed by a fraud analyst.

In conventional systems, a fraud analyst is provided with a list of such accounts that have undergone fraudulent activity. An account that has undergone fraudulent activity will be referred to herein as a “fraud case.” In conventional systems, a fraud analyst accesses a physical case file to manage each fraud case. The fraud case file contains printouts of screenshots from a mainframe computer system that relate to the account that is the subject of the case. In conventional systems, the fraud analyst would then access the mainframe computer to manage the fraud case. Once logged in to the mainframe computer, the fraud analyst manually navigates through the mainframe computer to research and manage the case. For example, the fraud analyst can attempt to locate previous charges made on the account. In the conventional system, the fraud analyst accesses data stored among multiple systems or regions. The fraud analyst does this manually, directly accessing the mainframe and viewing the information on a mainframe screen. In addressing the fraud case, the fraud analyst again manually navigates through the mainframe screens to view information. The fraud analyst is not prompted to perform any particular step, nor to view any particular data. Further, the fraud analyst is not provided with a straightforward user interface with applicable menu selections. Consequently, fraud analysts can spend an inordinate amount of time researching the fraud case on the mainframe system.

Numerous business and/or regulatory rules apply to the management of a fraud case, that is, rules instituted by the account-provider or provided for in regulations that govern how fraud cases are to be managed. The conventional system does not provide an automated means to apply such rules to ensure compliance. For example, the fraud analyst is generally required to notify the account holder regarding the case, and to seek a response from the account holder regarding whether certain charges were actually fraudulent. For example, certain business or regulatory rules require a response to such a letter within a certain number of days, for example, fourteen days. If a letter is not received after this predetermined time, another letter is to be sent, and/or the charges are deemed to be not fraudulent. Because conventional systems do not provide ready access to, and/or a mechanism to ensure compliance with such business and regulatory rules, a fraud analyst can fail to complete certain steps in the caselog management process. For example, a fraud analyst could send an initial letter, but fail to ensure that a response is received.

As such, because of the manual nature of the process, a fraud analyst can sometimes overlook a necessary step in the caselog fraud management process. Moreover, the conventional system does not provide for fraud case categorization, prioritization, and management. Finally, the conventional system does not store the fraud analyst's activities. As such, conventional methods do not allow for tracking the management of a fraud case for future reference.

The typical process for managing caselog fraud and chargeback is thus an inefficient, time-consuming, and potentially error-ridden process. In addition, the fraud analyst's activity can not be adequately tracked for purposes of billing, research, and analysis. The conventional process also leads to violation of business or compliance rules, as the rules are not readily available and fraud analysts must perform them manually. Accordingly, a need exists for systems and methods that streamline the process of managing caselog fraud and chargeback to ensure compliance with applicable rules, thus improving fraud management, providing greater efficiencies, fewer mistakes, and tracking capability.

### SUMMARY OF THE INVENTION

The present invention supports systems and methods for managing caselog fraud and chargeback to ensure compliance with account-provider, business, and regulatory rules. The systems and methods automate the process of managing a fraud case from a caselog or queue containing fraud cases and provide fraud analysts with a graphical user interface. The terms “fraud case” and “caselog” are used herein to refer to a financial account that has undergone fraudulent activity. “Queue” is used herein to refer to a lists of fraud cases (caselogs). The term “chargeback” is a reversal of a financial transaction, as a liability to the merchant, typically because of fraud. In addition, the systems and methods provide automatic display of available workflows and ensure compliance with the account-provider, business, and regulatory rules when workflows are performed. “Workflows” as used herein refer to actions taken to manage a fraud case. Workflows provide the functionality to prepare fraud cases, manage chargeback of a fraud case, and investigate a fraud case. Specifically, they may include: accessing data associated with a fraud case, manipulating data associated with the financial account, performing an activity in relation to the financial account, such as placing an outbound communication to an account holder, and/or linking to another workflow. For example, workflows can include “delete charges,” “order sales draft,” and “import charges.” The workflows described herein are complete sets of “instructions” provided to the fraud analyst through a graphical user interface that provide the fraud analyst with the necessary data, forms, and questions to effectively manage the fraud case without subtracting steps or violating a business or compliance rule. In other words, the workflows provide automatic navigation among their steps, automatically displaying screens and prompting the fraud analyst to address certain issues. In addition, the workflows displayed are customized to the type of fraud analyst accessing the system. Different types of fraud analysts are trained to manage different parts of the fraud management process, and include case preparer, chargeback specialist, and investigator. The systems and methods may also provide the ability to track and store activity performed in response to a fraud case.

One aspect of the invention provides a system for managing caselog fraud and chargeback including a fraud analyst workstation and is operable to: access fraud queues, each of the fraud queues including fraud cases; automatically access data associated with the fraud case among computer systems and mainframe regions; display workflows corresponding to the fraud case on a graphical user interface; perform workflows, where the workflows are based on predetermined rules and correspond to at least one of preparing, managing chargeback, and investigating a fraud case; provide automatic navigation through the workflows; automatically update the fraud queues; and store data related to the fraud case in a workflow database.

Another aspect of the invention provides a method for managing caselog fraud and chargeback, including the steps of: (a) accessing a fraud queue containing fraud cases; (b) selecting a fraud case from the fraud queue; (c) retrieving data associated with the selected fraud case; (d) displaying data associated with the fraud case on a graphical user interface; (e) displaying workflows on the graphical user interface, customized to a type of fraud analyst; (f) selecting workflows from the graphical user interface; (g) performing workflows in connection with the fraud case, the workflows based on predetermined rules; (h) storing the workflows performed in a workflow database; and (i) automatically updating the fraud queues.

Yet another aspect of the invention provides a system for managing caselog fraud and chargeback including: a fraud analyst workstation, including a fraud module operable to: access a fraud case; and display a graphical user interface including workflow options. The system also includes a workflow engine, logically connected to the fraud analyst workstation and operable to: automatically identify a location of data associated with the fraud case; store workflows, the workflows based on predetermined rules; automatically navigate through the workflows; and update the fraud queues. In addition, a host computer system is logically connected to the workflow engine and contains financial account data for fraud cases. Finally, the system includes a workflow database, logically connected to the workflow engine, and operable to store data associated with the fraud case.

### BRIEF DESCRIPTION OF THE DRAWINGS

FIG. 1 depicts a system architecture in accordance with an exemplary embodiment of the present invention.

FIG. 2 depicts an overall process flow diagram for managing caselog fraud and chargeback in accordance with an exemplary embodiment of the present invention.

FIG. 3 depicts a detailed process flow diagram for managing caselog fraud and chargeback in accordance with an exemplary embodiment of the present invention.

FIG. 4 depicts a detailed process flow diagram for accessing and performing a workflow in accordance with an exemplary embodiment of the present invention.

### DETAILED DESCRIPTION OF THE EXEMPLARY EMBODIMENTS

Exemplary embodiments of the present invention are provided. These embodiments include systems and methods that provide for the management of caselog fraud and chargeback. The systems and methods include the ability to manage a fraud case in a fraud queue; automatically locate the data associated with the fraud case; display workflows on a customized graphical user interface; automatically navigate through workflows that are based on predetermined rules specific to an account-provider, business, or regulation; store activity and data related to each fraud case; and automatically update the fraud queue. The systems and methods include a fraud analyst workstation, a workflow engine, a host computer system, and a workflow database that are logically connected to one another. The systems and methods include a fraud analyst workstation, a workflow engine, a host computer system, and a workflow database. The fraud analyst workstation communicates with the workflow engine, which stores and the workflows. The workflow engine communicates with the host computer system to access data associated with the fraud case. The workflow engine communicates with a workflow database, which stores activity and data related to each fraud case for purposes of tracking, billing, and research.

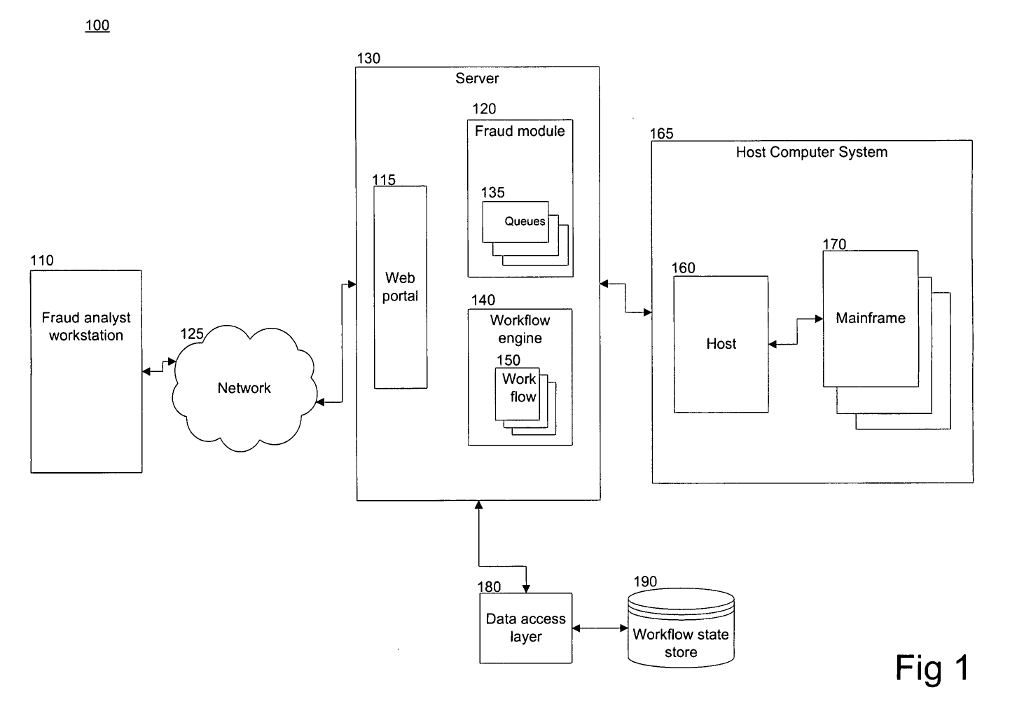

FIG. 1 depicts a system architecture 100 in accordance with an exemplary embodiment of the present invention. Referring to FIG. 1, the system architecture 100 includes a fraud analyst workstation 110. In this exemplary embodiment, a fraud analyst is a representative of a financial account processor responsible for managing fraud cases. The fraud analyst workstation 110 may be part of a local area network (LAN), wide area network, including the Internet, or a part of both types of networks. The fraud analyst workstation 110 may be connected to one or more computers (not shown) that control the programming and operation of the fraud analyst workstation 110. In this exemplary embodiment, the fraud analyst workstation 110 is used by a fraud analyst to manage fraud cases.

The fraud analyst workstation 110 can access the functionality of the server 130 by accessing the web portal 115 over the Internet. The network 125 can include the Internet, a dedicated communication line, shared network switch or other suitable network. As shown in FIG. 1, the fraud analyst workstation 110 can communicate by way of the network 125 with the server 130 using the web portal 115. The server 130 includes a fraud module 120. In this embodiment, the fraud module 120 need not reside on the workstation 110 because the workstation 110 is capable of accessing the application in a different location by using a thin client application, such as a web browser. Accordingly, the fraud module 120 can be located on the server 130, or in another location accessible via the network. (not shown).

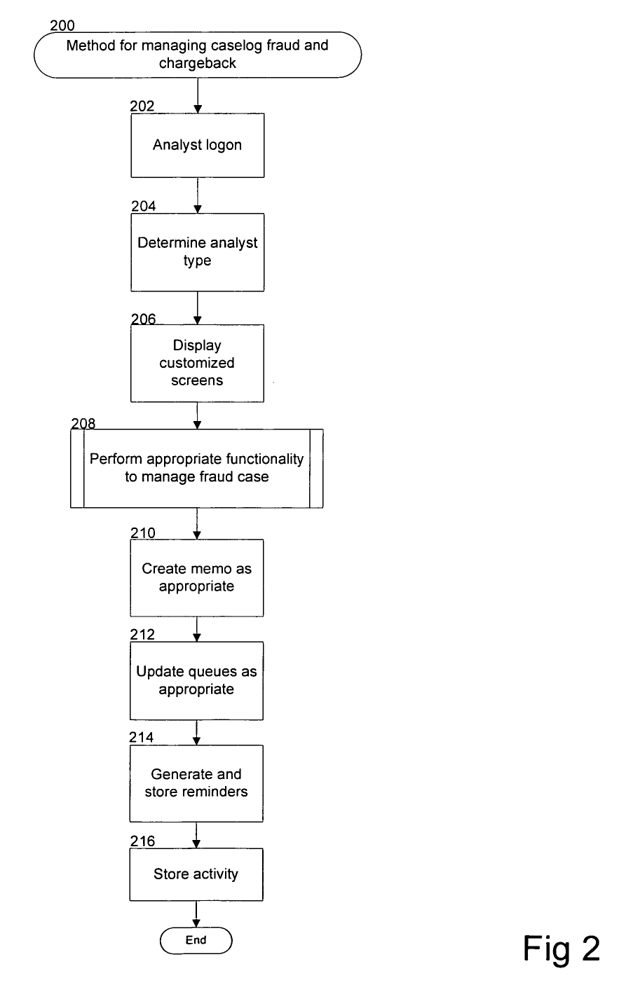

The server 130 includes a workflow engine 140, the web portal 115, and the fraud module 120. The workflow engine 140 is an application that stores the workflows 150 that can be accessed to manage the fraud cases. A fraud case includes information that can identify the account, including the account number, a bank, a credit card association, a name, a social security number, and an amount of a charge. Further, the fraud case can include other types of account identifiers, such as an address, a date of a charge, and a merchant related to the charge. The fraud module 120 is the application that controls the fraud management process. The fraud module 120 allows the analyst using the fraud analyst workstation 110 to efficiently access data and perform workflows to manage the fraud cases. The workflows and GUI will be described in more detail herein with reference to FIGS. 2-4. The fraud module 120 contains queues 135. Each queue 135 contains one or more fraud cases, as defined herein above. The queues 135 can be populated by an automated system that is operable to track, monitor, and flag account activity for potentially fraudulent activity. In addition, a fraud analyst or other representative of the account processor, in response to a call or other inquiry from the account holder, can populate the queues 135. Fraud cases can be grouped into queues 135 based on a variety of criteria. For example, each queue 135 can contain fraud cases for a single account-provider. “Account-provider” is used herein to refer to the account issuing entity, such as the national card association or financial institution. Alternatively, fraud cases can be grouped by an amount of the fraudulent charge, or the time it has been in the queue 135. The systems and methods described herein are operable will all varieties of queues 135.

The workflows 150 represent particular parts of the fraud management process. Workflows 150 include one or more coded steps in a fraud management process. These steps may include receiving data from the GUI, retrieving data, generating reports or information, and presenting information on the GUI. Each workflow 150 is designed based on rules specific to a business, regulation, and/or account-provider. Such rules are requirements and instructions that govern how a fraud case is handled and are provided for by a particular account provider, internal business policy, or regulation. The workflows 150 thus provide automatic navigation through the steps, while ensuring compliance with such rules.

When certain workflows 150 are applied, the workflow engine 140 can initiate access to the host computer system 165 to automatically access the relevant data. As such, for certain workflows, the fraud analyst need not separately log in to the host computer system 165, as this step is performed by the workflow engine 140. Additionally, at certain steps in the fraud management process, a fraud analyst may directly access the host computer system 165 to obtain and import charges related to a fraud case. An administrator can access the workflow engine 140 to add, delete, or change the workflows 150. For example, if an account-provider changes a rule, an administrator can reconfigure the workflow associated with that account-provider to reflect the change and ensure compliance with the new rule.

In this exemplary embodiment, the host computer system 165 includes a host 160. The host 160 is a large data processing system, which can store and access information related to the consumer's account. The host 160 can be a network server, web server, a mainframe computer, or another suitable host computer. The host 160 can access mainframes 170, where account information can be stored. The workflow engine 140, resident on the server 130 and running a workflow 150, accesses the host 160. In this embodiment, account holder data and other data related to a fraud case is stored among the mainframes 170 based on account-provider. Such data includes account holder information; account history; fraudulent charges; and other data related to the account. Additionally, because the server 130 communicates with the fraud analyst workstation 110 and the host computer system 165, data obtained from the mainframes 170 can be displayed on the GUI of the workstation 110.

The server 130 can also communicate with a data access layer 180. The data access layer 180 captures the activity of the workflow engine 140. Activity of the workflow engine 140 includes the workflows performed, and data accessed through host 160. In other words, the data access layer 180 can capture the inquiries made and actions performed in relation to each fraud case accessed by a fraud analyst. In addition, the data access layer 180 can capture other attributes of the management of a fraud case. For example, the data access layer 180 can capture the amount of time spent on the fraud case.

The data access layer 180 communicates with the workflow state store 190. The workflow state store 190 is a database used to store the activity captured by the data access layer 180. The workflow state store 190 stores such data for purposes of billing, tracking, and research as it pertains to fraud management. An administrator can access the workflow state store 190 for such purposes.

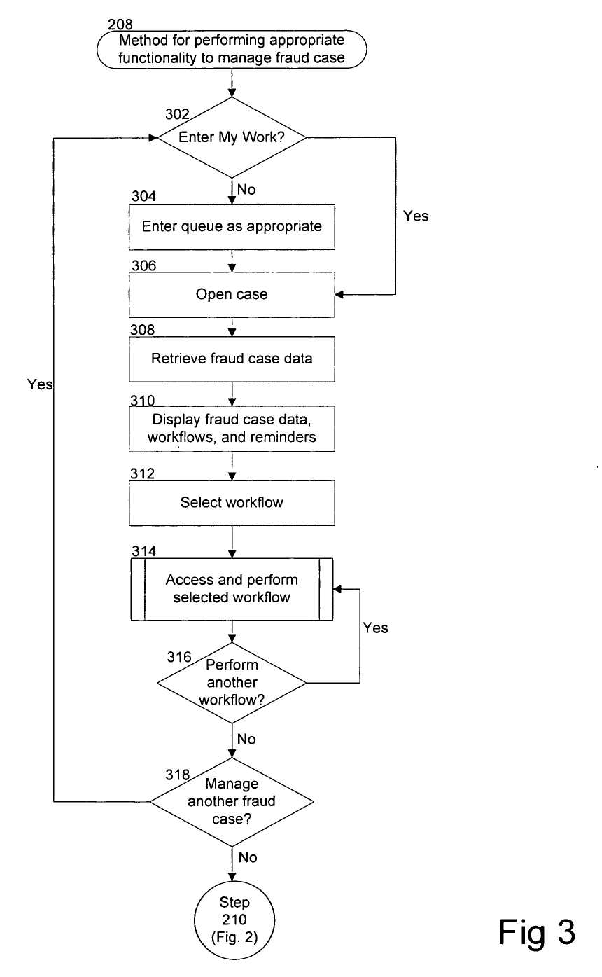

FIG. 2 depicts an overall process flow diagram 200 for managing caselog fraud and chargeback in accordance with an exemplary embodiment of the present invention. Referring to FIGS. 1 and 2, a process for managing caselog fraud and chargeback can be described. FIG. 3, discussed in detail below, provides additional details on this overall process.

At step 202, a fraud analyst logs on to the fraud analyst workstation 110. In particular, the fraud analyst accesses the fraud module 120 by way of the web portal 115. The fraud module 120 provides the fraud analyst with a GUI login screen. The fraud analyst uses an assigned login identification and password to logon to the fraud analyst workstation 110. In general, all activity performed by a fraud analyst in relation to the financial account is conducted using the GUI displayed on the fraud analyst workstation 110.

At step 204, the fraud module 120 determines the type of fraud analyst that logged on at step 202. Types of fraud analysts include case preparers, chargeback specialists, and investigators. Each type of fraud analyst manages a different aspect of the caselog fraud and chargeback process. Such separation of duties provides for ease in training and management. In an alternative embodiment, a single fraud analyst can manage the entire process, a selection of certain steps in the process, and/or an administrator can access all steps in the process. The particular fraud analyst type is determined by the fraud analysts' log in identification and password, which is stored in the server 130. A case preparer reviews fraud cases from a caselog to verify the accuracy of the fraud type and/or correct an inaccurate fraud type. The case preparer reviews charges on the mainframe, and pulls in fraudulent charges to the fraud module 120. Accordingly, the case preparer “prepares” cases for further management. A chargeback specialist is responsible for verifying whether the charges were made fraudulently, and subsequently for performing a chargeback, or reversing the transaction. An investigator investigates the fraud case and is eventually responsible for closing the case.

At step 206, the fraud analyst workstation 110 displays screens with customized functionality, customized to the type of fraud analyst determined at step 204. For example, the GUI display for a case preparer will include different screens and functionality than for a chargeback specialist.

At step 208, the fraud analyst conducts steps through the GUI that are appropriate to manage their portion of the fraud caselog and chargeback process. Step 208 will be discussed in more detail herein with reference to FIG. 3.

At step 210, the fraud analyst can create a memo to document the steps taken at step 208. For example, the fraud analyst can manually type notes into the memo indicating particular details related to the account, the account holder, the issues, and/or the action taken on the account. The memo created at step 210 provides documentation for future reference.

At step 212, a the workflow engine 140 updates the queues 135, to reflect any changes based on the activities taken by the fraud analyst. For example, if the fraud case is taken out of a queue during performance of a workflow 150, the fraud queue would be updated to reflect the change. As another example, if a “watch” is put on the account associated with the fraud case, the status of the fraud case would update accordingly in the queues 135. In addition, a fraud analyst and/or an administrator can add a fraud case to a queue known as a “hot list.” Hot lists are queues containing cases that meet a specific criteria, for example, open cases that have not been worked on for over five days. Accordingly, queues can be customized to provide efficient management of fraud cases and visibility as to fraud case status.

At step 214, the queues 135 automatically generate reminders. Reminders are stored in the fraud module 120, and will appear on the GUI of the fraud analyst workstation 110 at predetermined times to remind the fraud analyst to perform an action in relation to a fraud case. Reminders can be generated based on the type of queue 135 a fraud case is included in, and/or can be based on a workflow 150 performed on the fraud case. For example, for a particular “hot list” queue, a reminder can be set to appear after a fraud case has been in the “hot list” for more than five days. In addition, reminders can be customized by business, account-provider, and regulation. Accordingly, the reminders can reflect different timeframe requirements. For example, a national card association, such as VISA, can specify a time period of fourteen days to wait for an account holder to respond to a letter, before sending out a second letter. Similarly, a different account-provider may specify a time frame of only ten days for the same period.

At step 216, the workflow data store 190 stores the activity of a fraud analyst taken on the fraud analyst workstation 110 at steps 208-214. More particularly, the data access layer 180 continuously captures the activity performed, as it relates to each fraud case, by communicating with the server 130. The workflow state store 190 stores this data as described herein with reference to FIG. 1. The activity captured by the data access layer 180 and stored by the workflow state store includes: the particular caselogs and queues 135 that were selected and managed; the particular fraud cases within each queue 135 that were selected and managed; the particular workflow(s) that were selected, accessed, and/or performed; memos created; and documentation of any inbound or outbound communication with the account holder. The data access layer 180 also captures data related to the fraud case including: the account number; duration of management of each fraud case; and other measures related to fraud management. An administrator can access the workflow state store 190 to efficiently obtain information related to each queue 135 and/or fraud case, for purposes of billing an account-provider, tracking fraud analyst efficiency, and for statistical and research purposes.

FIG. 3 depicts a detailed process flow diagram 300 for managing caselog fraud and chargeback in accordance with an exemplary embodiment of the present invention. The method will be described herein with reference to FIGS. 1, 2 and 3.

At step 302, the fraud analyst determines whether to enter a personalized queue, known as “my work.” My work is a queue of personalized to a particular fraud analyst. A case preparer can assign a particular chargeback specialist and/or investigator to each fraud case to populate a fraud analyst's “my work.” Accordingly, when the particular chargeback specialist and/or investigator log on to the fraud analyst workstation 110, certain fraud cases will appear in their “my work.” If, at step 302, a determination is made that the fraud analyst has entered “my work,” the method proceeds to step 306, and the method proceeds as described herein below. If, at step 302, a determination is made that the fraud analyst will not enter “my work,” the method proceeds to step 304.

At step 304, the fraud analyst enters an appropriate queue 135. The fraud analyst workstation 110 displays the caselog or queue on the GUI, such as through a browser. The particular queue 135 displayed at step 304 is based on the type of fraud analyst. For example, a case preparer will work from a different queue than a chargeback specialist, because the different types of fraud analysts manage different parts of the fraud management process.

At step 306, the fraud analyst opens a fraud case from the caselog or queue displayed at step 304. The fraud analyst can open the fraud case by selecting it from the queue. The fraud analyst can select the fraud case by clicking on it on the GUI. If the fraud analyst had entered “my work,” the fraud analyst similarly selects a fraud case from the “my work” queue.

At step 308, the workflow engine 140 retrieves the account information associated with the fraud case selected at step 306. In addition, the fraud analyst, through the fraud analyst workstation 110, can access the host computer system 165. In this way, the system offers flexibility in retrieving information.

At step 310, the GUI on the fraud analyst workstation 110 displays the account information and appropriate workflows 150. The GUI displayed at step 312 includes customized menu options that lead to workflows 150. The workflows are customized depending on the account-provider, the account, and/or business and regulatory rules. In that regard, particular workflow may not be displayed if it does not apply to the account-provider associated with the fraud case. In addition, the workflows are customized based on the type of fraud analyst. For a case preparer, workflows can include: import charges, enter fraud type, and complete found fraud report. For a chargeback specialist, workflows can include order sales draft, request letter, and delete charges. For an investigator, workflows can include close case. At step 310, the GUI on the fraud analyst workstation 110 also displays the relevant reminders as they pertain to the fraud case and/or particular fraud analyst. Generation of reminders is described in more detail herein above with reference to step 214 of FIG. 2.

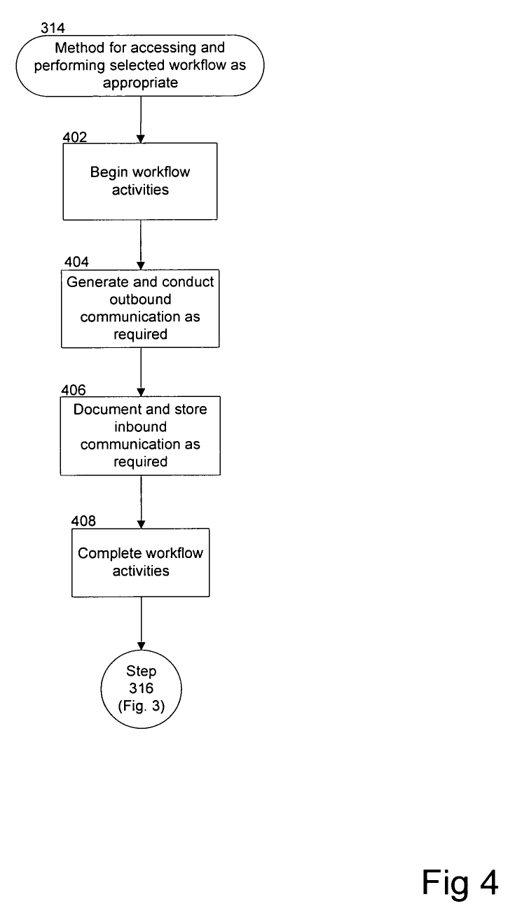

At step 312, the fraud analyst selects an appropriate workflow 150. The fraud analyst can select the workflow by clicking on the GUI. The particular workflows 150 will be described herein with reference to FIG. 4.

At step 314, the workflow engine 140 performs the selected workflow 150. Step 314 is described in more detail herein below with reference to FIG. 4.

At step 316, the fraud analyst determines whether another workflow is to be performed with regard to the fraud case. The workflow engine 140, in response to completion of a particular workflow, can prompt the fraud analyst to perform an additional workflow 150. Each workflow 150 includes a sequence of steps, displayed among one or more screens, to ensure that the workflow is completed efficiently and accurately. Accordingly, the workflow engine 140 automates the navigation of workflows 150 for the fraud analyst. In addition, a fraud analyst can manually select an additional workflow 150, based on the fraud case. If another workflow is to be performed, the method proceeds to step 314, and the method proceeds as described previously herein. If another workflow is not to be performed, then the method proceeds to step 318.

At step 318, the fraud analyst determines whether to work on another fraud case. If the determination is made to manage another fraud case, the method proceeds to step 302, and the method proceeds as described previously herein. By choosing to manage another fraud case at step 318, the fraud analyst can choose the fraud case from “my work,” and or another queue. If the determination is made to not manage another fraud case, the method proceeds to step 210 of FIG. 2.

FIG. 4 depicts a detailed process flow diagram 400 for managing caselog fraud and chargeback in accordance with an exemplary embodiment of the present invention. The method will be described herein with reference to FIGS. 1-4.

At step 402, the workflow engine 140 begins performance of the workflow 150 selected at step 312 of FIG. 3. The workflow engine 140 begins performance by accessing the appropriate workflow 150. Each workflow 150 embodies account-provider, business, and regulatory specific rules. Accordingly, when the particular workflow is selected and performed, the workflow is carried out in a manner that is compliant with these rules. For example, a particular account-provider may prohibit certain workflows from being performed on their account holders' accounts. For example, a certain account-provider may restrict management of fraud cases that involve fraudulent charges under a certain dollar amount, such as $30.00. Additionally, certain businesses may require a response to a fraud related letter within a certain number of days, for example, fourteen days. The step of beginning performance of a workflow also includes displaying screens associated with the workflow 150 on the GUI. The screen may take on a variety of formats. For example, the screens can display information about the account, such as fraudulent charges; a status of communications with the account holder; menu options; and/or forms. A workflow can be displayed on a single screen, multiple screens, or be embodied in the current display of the fraud analyst workstation 110. Certain workflows include multiple steps, thus requiring the fraud analyst to proceed through all the necessary steps of each workflow. In other words, the workflows provide automatic navigation among the steps of a process, thus ensuring that a fraud analyst cannot overlook a particular step. For example, the workflow to request a letter provides data on the GUI displaying options for the letter. The workflow then provides for printing and mailing of the letter. Finally, the workflow generates and stores a reminder. The reminder alerts the fraud analyst to send a second letter if, after a certain number of days, a response was not received from the initial letter. Accordingly, the workflows 150 can essentially walk the fraud analyst through screens that efficiently provide the relevant information, perform the requisite activities, and generate reminders to ensure effective completion of the fraud management process. In addition, workflows 150 can prompt the fraud analyst to document inbound communication, such as a sales draft, or a response to a letter. Such communications will be discussed in more detail herein with reference to step 404. Further, multiple workflows 150 can be performed in sequence, and one workflow can automatically link to another workflow. As such, workflows may be performed in varying sequences to ensure that the fraud cases are handled most efficiently. The data necessary to perform any of the workflows 150 are obtained when the workflow engine 140 initiates access to the host computer system 165, which locates the data among the mainframes 170. In addition, certain data may be stored in the fraud module 120. In turn, the data is displayed on the GUI on the fraud analyst workstation 110. In addition, the fraud analyst can access the host computer system 165 as needed to obtain certain data. For example, a case preparer generally obtains information, such as fraudulent charges, from the mainframe, and imports it into the fraud module 120.

At step 404, the fraud analyst, through the fraud analyst workstation 110, generates and conducts any outbound communications as required by the workflow 150. Outbound communications may include letters, telephone calls, emails, and/or another type of communication. For example, certain workflows can require the fraud analyst to send a letter and/or make a telephone call to an account holder. In particular, chargeback specialists typically communicate with the account holder to determine whether a particular charge is fraudulent. The chargeback specialist may also be required to obtain a copy of a sales draft from a merchant regarding a fraudulent charge. An image of the sales draft can be retrieved over the network 125, viewed on the GUI, and stored in the fraud module 120. The fraud module 120, by accessing the particular workflow 150, can automatically generate such communications. For example, a workflow 150 can automatically generate a form letter for the fraud analyst to send to an account holder. In an alternative embodiment, the workflow 150 can completely automate the process of generating and conducting an outbound communication, for example, by generating and sending electronic mail.

At step 406, the fraud analyst, through the fraud analyst workstation 110, documents and stores any inbound communications received, as required by the workflow 150. Inbound communications may include letters from account holders and/or sales drafts from merchants. The fraud analyst can document the receipt of such communications, as well as other details regarding the communication. In an alternative embodiment, the fraud analyst can additionally receive and store an electronic image of the inbound communication in the fraud module 120. The workflow engine 150 provides the requisite navigation and prompting of the fraud analyst to ensure that inbound communications are properly stored and documented.

At step 408, the workflow is completed. As described above with reference to step 402 of FIG. 4, the workflows can include a sequence of steps and display information using multiple screens. Completion of the workflow at step 408 simply means to perform any remaining steps of a the workflow selected at step 312 of FIG. 3. The workflow engine thus streamlines the approach to managing fraud cases. Provided herein are just a few examples of the many available types and configuration of workflows, and other workflows and workflow configurations can be made without departing from the spirit and scope of the invention.

One of ordinary skill in the art would appreciate that the present invention supports systems and methods for managing caselog and chargeback. The systems and methods may include the ability to access fraud cases through a variety of platforms, including electronic mail, formatted file, or directly from a financial account processing system. The systems and methods interact with a host computer system and a server to manage the fraud cases.

Although specific embodiments of the present invention have been described above in detail, the description is merely for purposes of illustration. Modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed:

1. A system for managing caselog fraud and chargeback comprising:
a fraud analyst workstation and operable to:
access a fraud queue comprising a fraud case;
select a fraud case from the fraud queue;
automatically access data associated with the fraud case among a computer system and a mainframe region;
display a list of workflow options corresponding to the fraud case on a graphical user interface, wherein a workflow is based on predetermined rules and corresponds to at least one of preparing, managing chargeback, and investigating a fraud case;
perform the workflow in response to a command from the fraud analyst workstation;
provide automatic navigation through the workflow;
automatically update the fraud queue; and
store data related to the fraud case in a workflow database.

2. The system of claim 1, wherein the fraud queue comprises fraud cases grouped by at least one of an account-provider; a risk level; an amount of a charge; and another type of fraud-related measure.

3. The system of claim 1, wherein the fraud case comprises at least one of an account number, a bank, a credit card association, a name, a social security number, an amount of a charge, and another type of account identifier.

4. The system of claim 1, wherein the list of workflow options displayed on the fraud analyst workstation is based on a type of a fraud analyst.

5. The system of claim 1, wherein the predetermined rules correspond to at least one of account-provider-specific, business-specific, and regulatory requirements.

6. The system of claim 1, wherein the workflow comprises steps corresponding to performing an activity in relation to the fraud case.

7. The system of claim 1, further comprising a data access layer, operable to capture and store in the workflow database, data related to the fraud case, the data related to the fraud case comprising at least one of: the financial account; the workflows performed; the data accessed; and other data related to the fraud case.

8. The system of claim 1, wherein an administrator can access the workflow database for purposes of at least one of: billing, tracking, statistical compilations, and research.

9. A method for managing caselog fraud and chargeback, comprising the steps of:
a) accessing a fraud queue comprising a fraud case;
b) selecting the fraud case from the fraud queue;
c) retrieving data associated with the selected fraud case;
d) displaying data associated with the fraud case on a graphical user interface;
e) displaying a list of workflow options on the graphical user interface, customized to a type of fraud analyst;
f) selecting the workflow from the graphical user interface;
g) performing the workflow in connection with the fraud case, the workflow based a predetermined rule;
h) storing the workflow performed in a workflow database; and
i) automatically updating the fraud queue.

10. The method of claim 9, wherein the fraud case comprises at least one of an account number, a bank, a credit card association, a name, a social security number, an amount of a charge, and another type of account identifier.

11. The method of claim 9, wherein the step of retrieving data associated with the selected fraud case further comprises accessing a computer system and a mainframe region.

12. The method of claim 9, wherein the predetermined rule corresponds to at least one of account-provider-specific, business-specific, and regulatory requirements.

13. The method of claim 9, wherein the workflow comprises automatic navigation through steps that correspond to performing an activity related to fraud case management.

14. The method of claim 13, wherein the activities related to fraud case management comprise at least one of preparing a fraud case; performing a chargeback on a fraud case; and investigating a fraud case.

15. The method of claim 9, wherein the step of performing the workflow in connection with the fraud case further comprises preventing performance of a workflow that is not compliant with the predetermined rule.

16. The method of claim 9, wherein an administrator can access the workflow database for purposes of at least one of: billing, tracking, statistical compilations, and research.

17. A system for managing caselog fraud and chargeback comprising:
a fraud analyst workstation, comprising a fraud module operable to:
access a fraud case;
display a graphical user interface comprising a list of workflow options; and
a workflow engine, logically connected to the fraud analyst workstation and operable to:
automatically identify a location of data associated with the fraud case;
store a workflow, the workflow based on a predetermined rule;
automatically navigate through the workflow; and
update the fraud queue;
the host computer system, logically connected to the workflow engine, comprising financial account data for the fraud case;
a workflow database, logically connected to the workflow engine, operable to store data associated with the fraud case.

18. The system of claim 17, wherein the predetermined rule comprise rules particular to at least one of: a bank, a credit card association, a regulatory agency, a law, and a business.

19. The system of claim 17, wherein the workflow engine is further operable to prohibit performance of workflows that violate the predetermined rule.

20. The system of claim 17, wherein the fraud module resides on a server accessible by the fraud analyst workstation.

21. The system of claim 17, wherein the workflow comprises steps corresponding to at least one of: preparing a fraud case; performing a chargeback on a fraud case; and investigating a fraud case.

22. The system of claim 21, wherein the workflow can further access a reminder in relation to a fraud case and display the reminder on the graphical user interface.

23. The system of claim 22, wherein the reminder comprises a notification to perform an activity in relation to the fraud case.

24. The system of claim 17, wherein an administrator can access the workflow engine for purposes of adding, deleting, and changing the workflow.

25. The system of claim 17, wherein the host computer system comprises a mainframe computer system.

26. The system of claim 17, wherein the data associated with the fraud case and stored by the workflow database comprises at least one of: the workflows performed in response to the fraud case; the financial account data; the location of the financial account data; and other properties of the fraud case.

27. The system of claim 17, wherein an administrator can access the workflow database for purposes of at least one of: billing, tracking, compiling statistics, and research.
